(19) United States
(12) Patent Application Publication
(10) Pub. No.: US 2006/0172091 A1
(43) Pub. Date: Aug. 3, 2006

(54) Substrate structure of liquid crystal display and method of forming alignment layer

(76) Inventors: Yuan-Hung Tung, Taoyuan (TW); Chih-Jui Pan, Taoyuan (TW)

Correspondence Address: J.C. Patents, Inc., Suite 250, 4 Venture, Irvine, CA, 92618, US

(21) Appl. No.: 11/338,141

(22) Filed: Jan. 23, 2006

(30) Foreign Application Priority Data
Feb. 2, 2005 (TW) 94103171

(51) Int. Cl. C09K 19/00; B05D 5/12

(52) U.S. Cl. 428/1.32; 427/535; 427/554; 427/58; 427/162

(57) ABSTRACT

A method of forming an alignment layer is described. A substrate comprising a display area and a non-display area is provided. A hydrophilic layer is formed on the substrate of the display area. A solution of an alignment material is dropped on the hydrophilic layer. The solution of the alignment material is solidified to form an alignment layer. Before dropping the solution of the alignment material on the hydrophilic layer, a hydrophobic layer may be formed on the substrate of the non-display area.

### CROSS-REFERENCE TO RELATED APPLICATION

This application claims the priority benefit of Taiwan application serial no. 94103171, filed on Feb. 2, 2005. All disclosure of the Taiwan application is incorporated herein by reference.

### BACKGROUND OF THE INVENTION

1. Field of the Invention

The present invention relates to a substrate structure of a liquid crystal display and a method of forming an alignment layer, and more particularly, to a method of forming an alignment layer in which a uniform alignment layer can be obtained.

2. Description of the Related Art

Recently, liquid crystal display devices which are slim and low-power consuming have been widely applied to personal computers, mobile phones, personal digital assistants, televisions, video cameras, and measuring instruments. Generally, a liquid crystal display is composed of two substrates and a liquid crystal layer between them. Regardless of an active matrix liquid crystal or a passive matrix liquid crystal display, an alignment layer must be disposed on each of the substrates. In addition, In order to achieve the goal of obtaining uniformly displaying of the liquid crystal display when voltages are applied to the electrodes of the substrates, a pretilt angle, that is the angle between the axis of the liquid crystal molecule and the surface of the alignment layer, is provided for liquid crystal molecules. Generally, the alignment layer is used to provide the pretilt angle for liquid crystal molecules.

For the time being, the method of forming an alignment layer comprises coating a solution of an alignment material on the substrate 100 by an inkjet method. FIG. 1 is a drawing showing a prior art inkjet coating method. The inkjet head 10 drops the solution of the alignment material 10a on the substrate 100. Generally, the inkjet methods include the thermal bubble inkjet process and the piezoelectric inkjet process. The piezoelectric inkjet process is more widely used. In the piezoelectric inkjet process, voltages are applied to pizeo-actuated plates (not shown) so that the pizeo-actuated plates deform and generate a pressure to compress and eject the solution of the alignment material 10a. The ejected solution of the alignment material 10a is then attached to the surface of the substrate 100. Therefore, the solution of the alignment material 10a can be coated on the desired area by controlling the operation and motion of the inkjet.

FIG. 2 is a top view of the substrate 100 in FIG. 1. The solution of the alignment material 10a dropped on the substrate 100 rests for a while, and then the solution of the alignment material 10a gradually distributes to form the layer 130 as shown in FIG. 3. After a baking process, an alignment layer is formed. One issue of this method is the poor uniformity of the alignment layer. In addition, it is hard to control the profile of the alignment layer. The quality of the alignment layer greatly affects the displaying quality of the liquid crystal display.

### SUMMARY OF THE INVENTION

Accordingly, the present invention is directed to a method of forming an alignment layer. The method can form an alignment layer with a uniform thickness and a desired profile on the surface of the substrate of the display area.

The present invention is also directed to a substrate structure of a liquid crystal display, which has an alignment layer with a uniform thickness and a desired profile.

Accordingly, the present invention provides a method of forming an alignment layer. In this method, a substrate is first provided. The substrate comprises a display area and a non-display area. A hydrophilic layer is formed on the surface of the substrate of the display area. A solution of an alignment material is dropped on the hydrophilic layer. The solution of the alignment material is solidified to form an alignment layer.

According to an embodiment of the present invention, the step of forming the hydrophilic layer is described below. A silicon oxide layer is formed on the substrate. The silicon oxide layer in the non-displayer area is then removed. A treatment step for the silicon oxide layer is performed so that the surface of the silicon oxide layer becomes hydrophilic.

Aaccording to an embodiment of the present invention, the treatment step for the silicon oxide layer comprises an ultra-violet (UV) exposure process, a laser process or a plasma process.

According to an embodiment of the present invention, the method further comprises forming a hydrophobic layer on the surface of the substrate of the non-display area after forming the hydrophilic layer and before dropping the solution of the alignment material on the hydrophilic layer.

According to an embodiment of the present invention, the step of forming the hydrophobic layer is described below. A material layer is deposited on the substrate. The material is selected from the group consisting of polysilicon, amorphous silicon, silicon nitride and a combination thereof. The material layer formed in the display area is then removed. A treatment step for the material layer is performed so that the surface of the material layer becomes hydrophobic.

According to an embodiment of the present invention, the treatment step for the material layer comprises an ultra-violet (UV) exposure process, a laser process or a plasma process.

According to an embodiment of the present invention, the substrate is a thin film transistor array substrate.

According to an embodiment of the present invention, the substrate is a color filter substrate.

The present invention provides another method of forming an alignment layer. In this method, a substrate is first provided. The substrate comprises a display area and a non-display area. A hydrophobic layer is formed on the surface of the substrate of the non-display area. A solution of an alignment material is dropped on the surface of the substrate of the display area. The solution of the alignment material is then solidified to form an alignment layer.

According to an embodiment of the present invention, the step of forming the hydrophobic layer is described below. A material layer is deposited on the substrate. The material is selected from a group consisting of polysilicon, amorphous silicon, silicon nitride and a combination thereof. The material layer on the surface of the substrate of the display area is then removed. A treatment step for the material layer is performed so that the surface of the material layer becomes hydrophobic.

According to an embodiment of the present invention, the treatment step for the material layer comprises an ultra-violet (UV) exposure process, a laser process or a plasma process.

According to an embodiment of the present invention, the substrate is a thin film transistor array substrate.

According to an embodiment of the present invention, the substrate is a color filter substrate.

The present invention further provides another method of forming an alignment layer. In this method, a substrate is first provided. The substrate comprises a display area and a non-display area. An isolation layer is formed on the surface of the substrate of the non-display area. In particular, the isolation layer has a height higher than a pre-determined height from the surface of the substrate. A solution of an alignment material is dropped on the surface of the substrate of the display area. The solution of the alignment material is solidified to form an alignment layer.

According to an embodiment of the present invention, the step of forming the isolation layer is described below. A photoresist layer is formed over the substrate, and then a photolithographic process is performed to pattern the photoresist layer.

According to an embodiment of the present invention, the substrate is a thin film transistor array substrate.

According to an embodiment of the present invention, the substrate is a color filter substrate.

The present invention further provides a substrate structure of a liquid crystal display which comprises a substrate, a hydrophilic layer and an alignment layer. The substrate comprises a display area and a non-display area. The hydrophilic layer is disposed on the surface of the substrate of the display area. In addition, the alignment layer is disposed on the hydrophilic layer.

According to an embodiment of the present invention, the hydrophilic layer is a silicon oxide layer and the surface of the silicon oxide layer is hydrophilic.

According to an embodiment of the present invention, the substrate structure of the liquid crystal display further comprises a hydrophobic layer which is disposed on the surface of the substrate of the non-display area.

According to an embodiment of the present invention, the hydrophobic layer is selected from the group consisting of a polysilicon layer, an amorphous silicon layer, a silicon nitride layer and a combination thereof, wherein each layer has a hydrophobic surface.

According to an embodiment of the present invention, the substrate is a thin film transistor array substrate.

According to an embodiment of the present invention, the substrate is a color filter substrate.

The present invention provides another substrate structure of a liquid crystal display which comprises a substrate, a hydrophobic layer, and an alignment layer. In particular, the substrate comprises a display area and a non-display area. The hydrophobic layer is disposed on the surface of the substrate of the non-display area. In addition, the alignment layer is disposed over the surface of the substrate of the display area.

According to an embodiment of the present invention, the hydrophobic layer is selected from the group consisting of a polysilicon layer, an amorphous silicon layer, a silicon nitride layer and a combination thereof, wherein each layer has a hydrophobic surface.

According to an embodiment of the present invention, the substrate is a thin film transistor array substrate.

According to an embodiment of the present invention, the substrate is a color filter substrate.

The present invention provides a substrate structure of a liquid crystal display which comprises a substrate, an isolation layer, and an alignment layer. In particular, the substrate comprises a display area and a non-display area. The isolation layer is disposed on the surface of the substrate of the non-display area, wherein the isolation layer has a height higher than a pre-determined height from the surface of the substrate. In addition, the alignment layer is disposed on the surface of the substrate of the display area.

According to an embodiment of the present invention, the pre-determined height is from 500 Å to 1100 Å.

According to an embodiment of the present invention, the material of the isolation layer is a photoresist material.

According to an embodiment of the present invention, the substrate is a thin film transistor array substrate.

According to an embodiment of the present invention, the substrate is a color filter substrate.

In the method of forming the alignment layer of the present invention, a hydrophilic layer is formed on the surface of the substrate of the display area and/or a hydrophobic layer is formed on the surface of the substrate of the non-display area. By using the hydrophilic and/or hydrophobic layer to define the area of the alignment layer, the uniformity of the layer can be achieved. As a result, the method of forming the alignment layer according to the present invention provides better film properties for the alignment layer, and thus the displaying quality of the liquid crystal display is improved.

The above and other features of the present invention will be better understood from the following detailed description of the preferred embodiments of the invention that is provided in communication with the accompanying drawings.

### BRIEF DESCRIPTION OF THE DRAWINGS

FIG. 1 is a drawing showing an inkjet coating method in the prior art.

FIG. 2 is a top view of the substrate 100 in FIG. 1.

FIG. 3 is a drawing showing an alignment with non-uniform thickness and profile.

FIGS. 4A-4E are cross sectional views showing a method of forming an alignment layer according to a first embodiment of the present invention.

FIG. 4F is a top view showing the profile of the alignment layer.

FIGS. 5A-5E are cross sectional views showing a method of forming an alignment layer according to a second embodiment of the present invention.

FIG. 5F is a top view showing the profile of the alignment layer.

FIG. 6A-6F are cross sectional views showing a method of forming an alignment layer according to a third embodiment of the present invention.

FIG. 6G is a top view showing the profile of the alignment layer.

FIGS. 7A-7D are cross sectional views showing a method of forming an alignment layer according to a fourth embodiment of the present invention.

FIG. 7E is a top view showing the profile of the alignment layer.

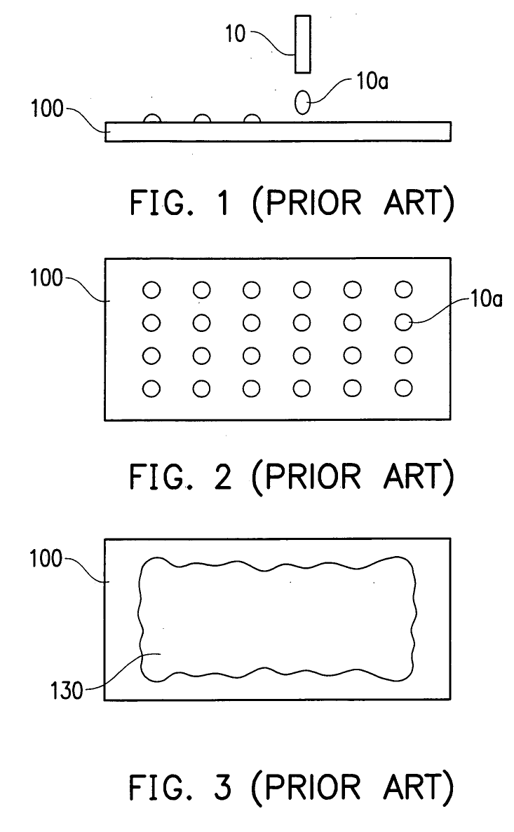

### DESCRIPTION OF SOME EMBODIMENTS

### First Embodiment

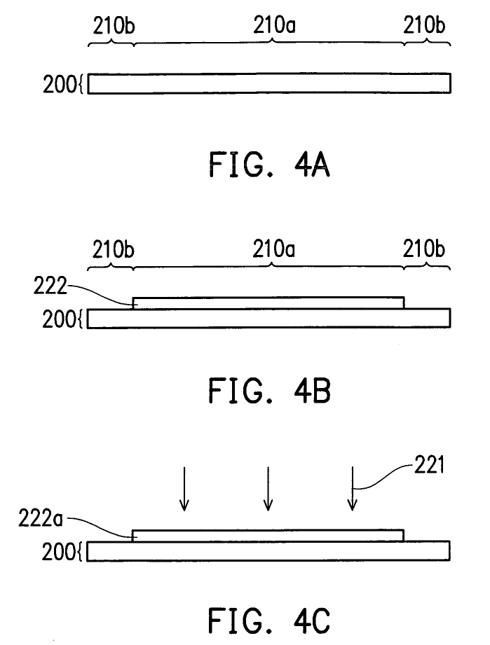

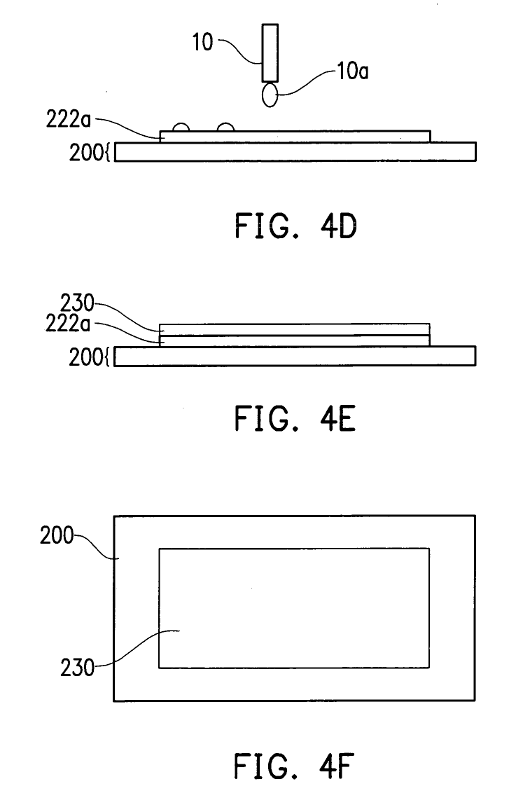

FIGS. 4A-4E are cross sectional views showing a method of forming an alignment layer according to a first embodiment of the present invention. Referring to FIG. 4A, a substrate 200 is first provided. The substrate 200 comprises a display area 210a and a non-display area 210b. In an embodiment, the substrate 200 can be, for example, a thin film transistor array substrate which comprises, for example, thin film transistors (TFTs), indium-tin-oxide (ITO) pixel electrodes, scan lines and data lines. In another embodiment, the substrate 200 can be, for example, a color filter substrate which comprises red, green and blue resins, black matrixes (BMs) and common electrodes.

Then, a hydrophilic layer 222a is formed on the surface of the substrate 200 of the display area 210a. In a preferred embodiment, the method of forming the hydrophilic layer 222a is described below. Referring to FIG. 4B, a silicon oxide layer 222 is first deposited on the substrate 200, for example, by a chemical vapor deposition (CVD) method. A photolithographic process and an etching process are then performed to remove the silicon oxide layer 222 on the surface of the substrate 200 of the non-display area 210b and remain the silicon oxide layer 222 in the display area 210a.

Referring to FIG. 4C, a treatment step 221 for the silicon oxide layer 222 in the display area 210a is performed so that the surface of the silicon oxide layer 222 becomes hydrophilic, and a hydrophilic layer 222a is thus formed. The treatment step 221 can be, for example, an ultra-violet (UV) light exposure process, a laser process or a plasma process. In the treatment step 221, a mask (not shown) may be used to expose the silicon oxide layer 222 of the display area 210a and to cover the non-display area 210b, for example. If the laser process is performed on the silicon oxide layer 222, the use of the mask is optional. The plasma process comprises, for example, oxygen plasma or hydrogen plasma.

Referring to FIG. 4D, after forming the hydrophilic layer 222a, an inkjet head 10 or other methods are used to drop a solution of an alignment material 10a on the hydrophilic layer 222a. Note that the solution of the alignment material 10a is a hydrophilic material, such as polyimide, poly(vinyl alcohol), or polyamide. Therefore, the solution of the alignment material 10a can be easily and uniformly distributed on the surface of the hydrophilic layer 222a.

Referring to FIG. 4E, the solution of the alignment material 10a rests a while and distributes on the surface of the hydrophilic layer 222a. Then, a solidification process is performed so as to form an alignment layer 230. In this embodiment, the solidification process can be, for example, a baking process.

Because both the solution of the alignment material 10a and the surface of the hydrophilic layer 222a are hydrophilic, the solution of the alignment material 10a can easily and evenly distribute on the surface of the hydrophilic layer 222a. After the solidification of the solution of the alignment material 10a, a uniform layer is formed.

In addition, the location of the hydrophilic layer 222a can be used to define the profile of the alignment layer 230. In detail, due to the restriction of the interaction force between the surface of the hydrophilic layer 222a and the surface of the solution of the alignment material 10a, the dropped solution of the alignment material 10a hardly distributes out of the area of the hydrophilic layer 222a. As a result, the profile of the alignment layer 230 can be defined. Referring to FIG. 4F, it shows the top view of the profile of the alignment layer 230. After forming the alignment layer 230, the method may further comprise subsequent processes, such as a rubbing process to the alignment layer 230.

Accordingly, a substrate structure of a liquid crystal display formed according to the method described is shown in FIG. 4E. The substrate structure of the liquid crystal display comprises a substrate 200, a hydrophilic layer 222a and an alignment layer 230. The substrate 200 comprises a display area 210a and a non-display area 210b. The hydrophilic layer 222a is disposed on the substrate 200 of the display area 210a. Additionally, the alignment layer 230 is disposed on the hydrophilic layer 222a.

### Second Embodiment

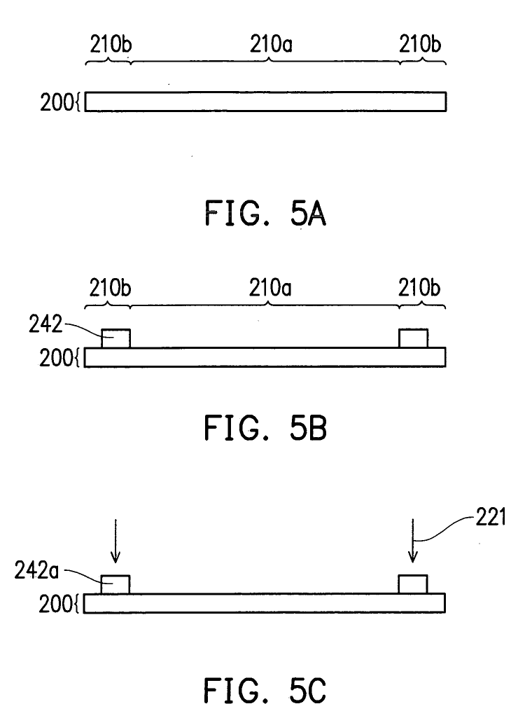

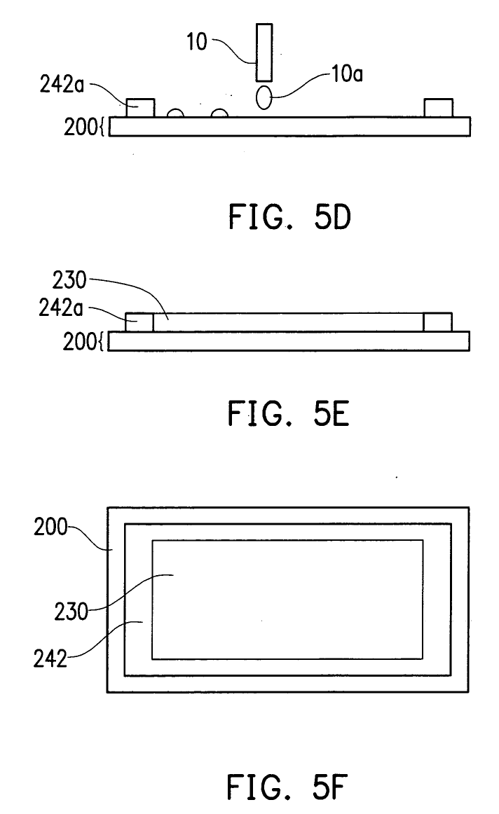

FIGS. 5A-5E are cross sectional views showing a method forming an alignment layer according to a second embodiment of the present invention. Referring to FIG. 5A, a substrate 200 is first provided. The substrate 200 comprises a display area 210a and a non-display area 210b. The substrate 200 can be, for example, a thin film transistor array substrate or a color filter substrate.

Then, a hydrophobic layer 242a is formed on the substrate 200 of the non-display area 210b. In a preferred embodiment, the method of forming the hydrophobic layer 242a is described below.

Referring to FIG. 5B, first a material layer 242 is deposited on the substrate 200, for example, by a plasma-enhanced chemical vapor deposition (PECVD) method. The material layer 242 can be, for example, a polysilicon layer, an amorphous silicon layer, a silicon nitride layer, or a combination thereof. A photolithographic process and an etching process are then performed to remain the material layer 242 in the non-display area 210b.

Referring to FIG. 5C, a treatment step 221 for the material layer 242 in the non-display area 210b is performed so that the surface of the material layer 242 becomes hydrophobic, and a hydrophobic layer 242a is thus formed. The treatment step 221 for the material layer 242 can be, for example, an ultra-violet (UV) light exposure process, a laser process or a plasma process.

In the treatment step 221, a mask (not shown) may further be used to expose the material layer 242 of the non-display area 210b and to cover the display area 210a, for example. If the laser process is performed on the material layer 242, the use of the mask is optional. The plasma process comprises, for example, oxygen plasma or hydrogen plasma. The present invention, however, is not limited thereto. As long as making the surface of the material layer 242 hydrophobic, any method can be used.

Referring to FIG. 5D, an inkjet head 10 or other methods are used to drop the solution of the alignment material 10a on the substrate 200 of the display area 210a. Because the solution of the alignment material 10a is a hydrophilic material, the solution of the alignment material 10a can be easily separated from the hydrophobic layer 242a. Due to the characteristic difference between the solution of the alignment material 10a and the hydrophobic layer 242a, the profile of the alignment layer 230a can be defined.

Referring to FIG. 5E, the solution of the alignment material 10a dropped in the display area 210a rests for a while and gradually distributes. Then, a solidification process is performed to form the alignment layer 230. In this embodiment, the solidification process can be, for example, a baking process. Referring to FIG. 5F, it shows the top view of the profile of the alignment layer 230. The location of the hydrophobic layer 242a can also be used to define the profile of the alignment layer 230. Accordingly, the profile design of the alignment layer 230 becomes more flexible.

Accordingly, a substrate structure of a liquid crystal display formed according to the method described is shown in FIG. 5E. The substrate structure of the liquid crystal display comprises a substrate 200, a hydrophobic layer 242a and an alignment layer 230. The substrate 200 comprises a display area 210a and a non-display area 210b. The hydrophobic layer 242a is disposed on the substrate 200 of the non-display area 210b. Additionally, the alignment layer 230 is disposed on the substrate 200 of the display area 210a.

### Third Embodiment

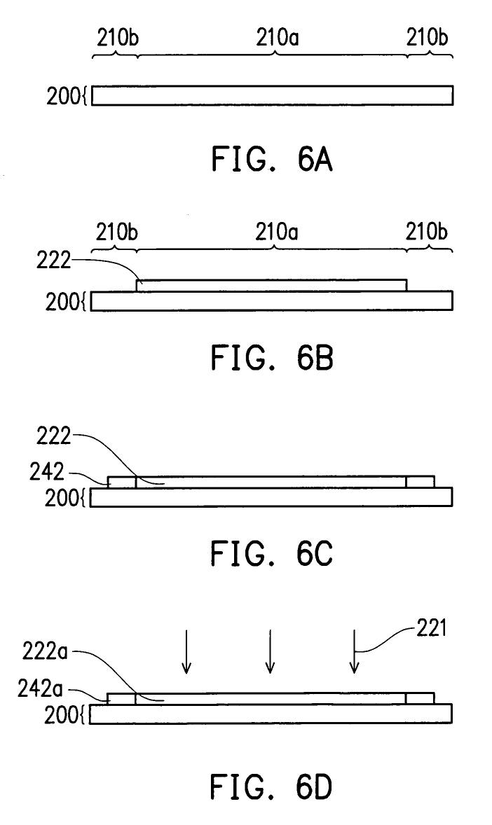

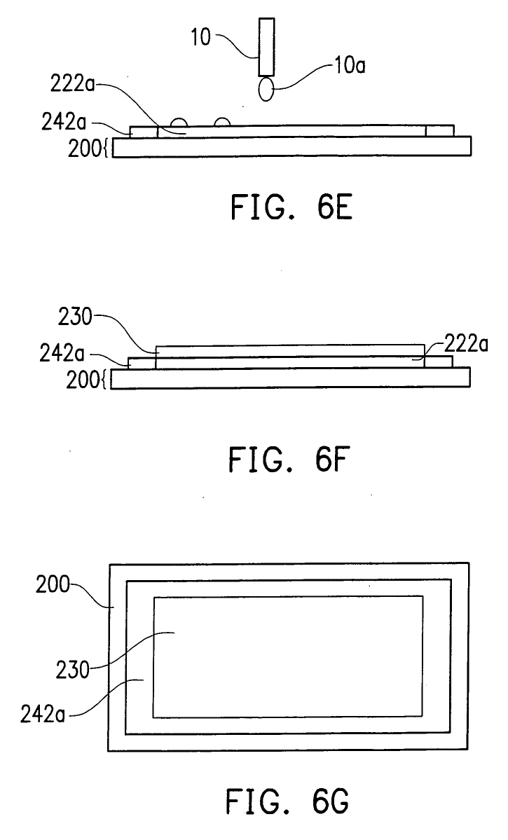

This embodiment is an application of combining the processes of the first embodiment and the second embodiment. FIGS. 6A-6F are cross sectional views showing a method of forming an alignment layer according to a third embodiment of the present invention. Referring to FIGS. 6A and 6B, which show the steps of forming the patterned silicon oxide layer 222, as described in the first embodiment. Referring to FIG. 6C, it shows forming the patterned material layer 242 in the non-display area 210b, as described in the second embodiment.

Referring to FIG. 6D, a treatment step 221 is performed to the silicon oxide layer 222 in the display area 210a and the material layer 242 in the non-display area 210b so that the silicon oxide layer 222 becomes a hydrophilic layer 222a and the material layer 242 becomes a hydrophobic layer 242a. The treatment step 221 can be, for example, a UV light exposure process, a laser process or a plasma process. The hydrophilic layer 222a and the hydrophobic layer 242a substantially have the same thickness, for example.

Referring to FIGS. 6E and 6F, an inkjet head 10 or other methods are used to drop the solution of the alignment material 10a on the hydrophilic layer 222a in the display area 210a. The solution of the alignment material 10a dropped rests a while and gradually distributes. Then, a solidification process is performed so as to form the alignment layer 230. Note that both the solution of the alignment material 10a and the hydrophilic layer 222a are hydrophilic. As a result, the solution of the alignment material 10a uniformly distributes on the surface of the hydrophilic layer 222a. The solidified solution of the alignment material 10a thus forms a uniform layer.

In addition, the solution of the alignment material 10a is separated by the material with the hydrophobic surface feature. Therefore, the solution of the alignment material 10a does not distribute on the hydrophobic layer 242a and the profile of the alignment layer 230 can be maintained. Referring to FIG. 6G, it shows the top view of the profile of the alignment layer.

Accordingly, a substrate structure of a liquid crystal display formed according to the method described is shown in FIG. 6F. The substrate structure of the liquid crystal display comprises a substrate 200, a hydrophilic layer 222a, a hydrophobic layer 242a and an alignment layer 230. The substrate 200 comprises a display area 210a and a non-display area 210b. The hydrophilic layer 222a is disposed on the substrate 200 of the display area 210a. The hydrophobic layer 242a is disposed on the substrate 200 of the non-display area 210b. Additionally, the alignment layer 230 is disposed on the hydrophilic layer 222a.

### Fourth Embodiment

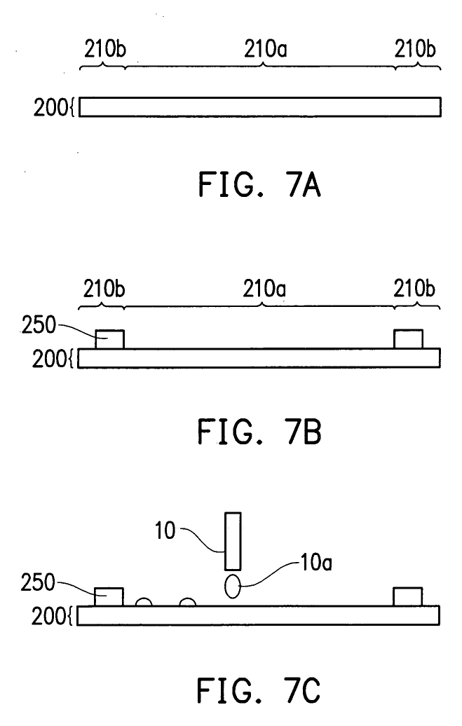

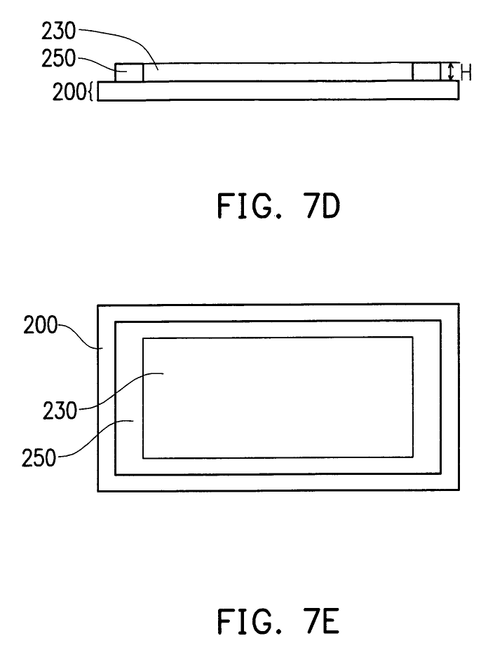

FIGS. 7A-7D are cross sectional views showing a method of forming an alignment layer according to a fourth embodiment of the present invention. This embodiment is similar to the second embodiment. The step shown in FIG. 7A is similar to that shown in FIG. 5A. Referring to FIG. 7B, an isolation layer 250 is formed on the substrate 200 of the non-display area 210b. The isolation layer 250 can be formed by photoresist material, for example. The difference between the fourth embodiment and the second embodiment is that the hydrophobic layer is formed in the non-display area 210b in the second embodiment, but the photoresist isolation layer 250 is formed in the non-display area 210b. Both of them are to define the profile of the alignment layer 230. The steps in FIGS. 7C and 7D are similar to those in FIGS. 5D and 5E. The profile of the alignment layer is shown in FIG. 7E.

Note that in this embodiment, the thickness of the isolation layer 250 is higher than a pre-determined height H from the surface of the substrate 200. Generally, the thickness of the alignment layer 230 is in a range of 500 Å to 1100 Å. Accordingly, the pre-determined height H is in a range of about 500 Å to 1100 Å. In detail, if the liquid crystal display is a Twist Nematic liquid crystal display, the pre-determined height H is about 700±200 Å. In order to make sure the isolation performance of the isolation layer 250, it is suggested that the thickness of the isolation layer 250 be at least larger than 900 Å. In addition, if the liquid crystal display is a vertical alignment liquid crystal display, the pre-determined height H should be about 900±200 Å. Similarly, it is suggested that the thickness of the isolation layer 250 should be at least larger than 1100 Å. In other words, the thickness of the isolation layer 250 varies with the thickness of the alignment layer.

Accordingly, the substrate structure of the liquid crystal display formed according to the method described is shown in FIG. 7D. The substrate structure of the liquid crystal display comprises a substrate 200, an isolation layer 250 and an alignment layer 230. The substrate 200 comprises a display area 210a and a non-display area 210b. The isolation layer 250 is disposed in the non-display area 210b of the substrate 200. Additionally, the alignment layer 230 is disposed in the display area 210a of the substrate 200.

Accordingly, the method of forming the alignment layer according to the present invention has the following advantages.

1. By the method of forming the alignment layer according to the present invention, a hydrophilic layer is formed on the substrate of the display area. The hydrophilic layer makes the solution of the alignment material uniformly and evenly distributed. Thus, the uniformity of thickness and profile of the alignment layer can be effectively controlled.

2. By the method of forming the alignment layer according to the present invention, a hydrophobic layer or an isolation layer is formed on the substrate of the non-display area. By using the surface feature of the hydrophobic layer or the location of the isolation layer, the profile of the alignment layer can be defined. Moreover, the uniformity of thickness of the alignment layer can also be obtained.

3. In the method of forming the alignment layer of the present invention, the profile of the alignment layer can be defined by the hydrophobic and/or hydrophilic layer or the isolation layer. Accordingly, the design of the alignment layer becomes more flexible.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A method of forming an alignment layer, comprising:
providing a substrate comprising a display area and a non-display area;
forming a hydrophilic layer on the substrate of the display area;
dropping a solution of an alignment material on the hydrophilic layer; and
solidifying the solution of the alignment material to form an alignment layer.

2. The method of forming an alignment layer of claim 1, wherein the step of forming the hydrophilic layer comprises:
forming a silicon oxide layer on the substrate;
removing the silicon oxide layer in the non-displayer area; and
performing a treatment step for the silicon oxide layer so that the surface of the silicon oxide layer becomes hydrophilic.

3. The method of forming an alignment layer of claim 2, wherein the treatment step for the silicon oxide layer comprises an ultra-violet (UV) exposure process, a laser process or a plasma process.

4. The method of forming an alignment layer of claim 1, further comprising forming a hydrophobic layer on the substrate of the non-display area after forming the hydrophilic layer and before dropping the solution of the alignment material on the hydrophilic layer.

5. The method of forming an alignment layer of claim 4, wherein the step of forming the hydrophobic layer comprises:
depositing a material layer on the substrate, wherein the material layer is selected from the group consisting of polysilicon, amorphous silicon, silicon nitride and a combination thereof;
removing the material layer in the display area; and
performing a treatment step for the material layer so that the surface of the material layer becomes hydrophobic.

6. The method of forming an alignment layer of claim 5, wherein the treatment step for the material layer comprises an ultra-violet (UV) exposure process, a laser process or a plasma process.

7. The method of forming an alignment layer of claim 1, wherein the substrate is a thin film transistor array substrate.

8. The method of forming an alignment layer of claim 1, wherein the substrate is a color filter substrate.

9. A method of forming an alignment layer, comprising:
providing a substrate comprising a display area and a non-display area;
forming a hydrophobic layer on the substrate of the non-display area;
dropping a solution of an alignment material on the substrate of the display area; and
solidifying the solution of the alignment material to form an alignment layer.

10. The method of forming an alignment layer of claim 9, wherein the step of forming the hydrophobic layer comprises:
depositing a material layer on the substrate, wherein the material layer is selected from the group consisting of polysilicon, amorphous silicon, silicon nitride and a combination thereof;
removing the material layer in the display area; and
performing a treatment step to the material layer so that the surface of the material layer becomes hydrophobic.

11. The method of forming an alignment layer of claim 10, wherein the treatment step for the material layer comprises an ultra-violet (UV) exposure process, a laser process or a plasma process.

12. The method of forming an alignment layer of claim 9, wherein the substrate is a thin film transistor array substrate.

13. The method of forming an alignment layer of claim 9, wherein the substrate is a color filter substrate.

14. A method of forming an alignment layer, comprising:
providing a substrate comprising a display area and a non-display area;
forming an isolation layer on the surface of the substrate of the non-display area, wherein the isolation layer has a height higher than a pre-determined height from the surface of the substrate;
dropping a solution of an alignment material on the surface of the substrate of the display area; and
solidifying the solution of the alignment material to form an alignment layer.

15. The method of forming an alignment layer of claim 14, wherein the step of forming the isolation layer comprises:
forming a photoresist layer on the substrate; and
performing a photolithographic process to pattern the photoresist layer.

16. The method of forming an alignment layer of claim 14, wherein the substrate is a thin film transistor array substrate.

17. The method of forming an alignment layer of claim 14, wherein the substrate is a color filter substrate.

18. A substrate structure of a liquid crystal display, comprising:
a substrate comprising a display area and a non-display area;
a hydrophilic layer disposed on the substrate of the display area; and
an alignment layer disposed on the hydrophilic layer.

19. The substrate structure of the liquid crystal display of claim 18, wherein the hydrophilic layer is a silicon oxide layer, and the silicon oxide layer has a hydrophilic surface.

20. The substrate structure of the liquid crystal display of claim 18, further comprising a hydrophobic layer, disposed on the substrate of the non-display area.

21. The substrate structure of the liquid crystal display of claim 20, wherein the hydrophobic layer is selected from the group consisting of a polysilicon layer, an amorphous silicon layer, a silicon nitride layer and a combination thereof, and each layer has a hydrophobic surface.

22. The substrate structure of the liquid crystal display of claim 18, wherein the substrate is a thin film transistor array substrate.

23. The substrate structure of the liquid crystal display of claim 18, wherein the substrate is a color filter substrate.

24. A substrate structure of a liquid crystal display, comprising:
a substrate comprising a display area and a non-display area;
a hydrophobic layer disposed on the substrate of the non-display area; and
an alignment layer disposed on the substrate of the display area.

25. The substrate structure of the liquid crystal display of claim 24, wherein the hydrophobic layer is selected from the group consisting of a polysilicon layer, an amorphous silicon layer, a silicon nitride layer and a combination thereof, and each layer has a hydrophobic surface.

26. The substrate structure of the liquid crystal display of claim 24, wherein the substrate is a thin film transistor array substrate.

27. The substrate structure of the liquid crystal display of claim 24, wherein the substrate is a color filter substrate.

28. A substrate structure of a liquid crystal display, comprising:
a substrate comprising a display area and a non-display area;
an isolation layer, disposed on the substrate of the non-display area, wherein the isolation layer has a height higher than a pre-determined height from the surface of the substrate;
an alignment layer, disposed on the substrate of the display area.

29. The substrate structure of the liquid crystal display of claim 28, wherein the pre-determined height is from 500 Å to 1100 Å.

30. The substrate structure of the liquid crystal display of claim 28, wherein a material of the isolation layer is a photoresist material.

31. The substrate structure of the liquid crystal display of claim 28, wherein the substrate is a thin film transistor array substrate.

32. The substrate structure of the liquid crystal display of claim 28, wherein the substrate is a color filter substrate.
